(19) United States
(12) Patent Application Publication
(10) Pub. No.: US 2019/0146111 A1
(43) Pub. Date: May 16, 2019

(54) APPLYING ORTHOGONALIZATION FILTERING TO WAVEFIELD SEPARATION

(71) Applicant: Saudi Arabian Oil Company, Dhahran (SA)

(72) Inventors: Woodon Jeong, Dhahran (SA); Constantinos Tsingas, Dhahran (SA); Young Seo Kim, Abqaiq (SA)

(73) Assignee: Saudi Arabian Oil Company, Dhahran (SA)

(21) Appl. No.: 15/810,779

(22) Filed: Nov. 13, 2017

(51) Int. Cl. G01V 1/36

(52) U.S. Cl. CPC G01V 1/364; G01V 2210/23

(57) ABSTRACT

The present disclosure describes methods and systems, including computer-implemented methods, computer program products, and computer systems for applying orthogonalization filtering to wavefield separation. One computer-implemented method includes obtaining multi-component wavefields, performing wavefield separation on the multi-component wavefields to obtain separated wavefields, and applying a local orthogonalization weight (LOW) filtering to the separated wavefields to obtain filtered wavefields.

### TECHNICAL FIELD

This disclosure relates to seismic data processing and, more specifically, to applying orthogonalization filtering to wavefield separation.

### BACKGROUND

P-wavefield and S-wavefield separation has been used to separate elastic multi-component wavefields in the time and space domains. However, substantial residual energy remains in the decomposed wavefields.

### SUMMARY

The present disclosure describes methods and systems, including computer-implemented methods, computer program products, and computer systems for applying orthogonalization filtering to wavefield separation. One computer-implemented method includes obtaining multi-component wavefields, performing wavefield separation on the multi-component wavefields to obtain separated wavefields, and applying a local orthogonalization weight (LOW) filtering to the separated wavefields to obtain filtered wavefields.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes the system to perform the actions. One or more computer programs can be configured to perform particular operations or actions by virtue of including instructions that, when executed by data processing apparatus, cause the apparatus to perform the actions.

The foregoing and other implementations can each, optionally, include one or more of the following features, alone or in combination:

A first aspect, combinable with the general implementation, comprising, comprising generating a depth image based on the filtered wavefields.

A second aspect, combinable with any of the previous aspects, wherein the multi-component wavefields are formed using a time-domain elastic wave propagation model based on first-order 2D elastic wave equations, and the multi-component wavefields include a horizontal component and a vertical component.

A third aspect, combinable with any of the previous aspects, wherein the separated wavefields include at least one of a P-wavefield for the horizontal component, a P-wavefield for the vertical component, an S-wavefield for the horizontal component, or an S-wavefield for the vertical component.

A fourth aspect, combinable with any of the previous aspects, comprising, decoupling the first-order 2D elastic wave equations into separate P-wave and S-wave components, and separating the multi-component wavefields based on the decoupled first-order 2D elastic wave equations.

A fifth aspect, combinable with any of the previous aspects, wherein first-order 2D elastic wave equations are written in a stress and particle-velocity formulation, and decoupling the first-order 2D elastic wave equations is performed using a set of equations associated with compressional wave components providing P-wave stress and particle-velocity for both the horizontal component and the vertical component.

A sixth aspect, combinable with any of the previous aspects, wherein applying the LOW filtering comprises, for each wavefield in the separated wavefields, calculating a local orthogonalization weight, and obtaining a filtered wavefield by applying the calculated local orthogonalization weight to a corresponding component of the multi-component wavefields.

A seventh aspect, combinable with any of the previous aspects, wherein the wavefield separation is performed using a P-wavefield and S-wavefield separation method.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the following description. Other features and advantages of the disclosure will be apparent from the description and drawings, and from the claims.

### BRIEF DESCRIPTION OF THE DRAWINGS

FIG. 1 illustrates example snapshots of horizontal and vertical wavefields, according to some implementations.

FIG. 2 illustrates example snapshots of separated P-wavefield and S-wavefield, according to some implementations.

FIG. 3 is a diagram illustrating an example orthogonality between signal and noise, according to some implementations.

FIG. 4 illustrates example snapshots of filtered P-wavefield and S-wavefield, according to some implementations.

FIG. 5 is a flowchart illustrating an example method for applying orthogonalization filtering to wavefield separation, according to some implementations.

FIG. 6 illustrates example snapshots of normalized gradient directions, according to some implementations.

FIG. 7 is a block diagram illustrating an example computer system used to provide computational functionalities associated with described algorithms, methods, functions, processes, flows, and procedures as described in the instant disclosure, according to some implementations.

Like reference numbers and designations in the various drawings indicate like elements.

### DETAILED DESCRIPTION

The following detailed description describes applying orthogonalization filtering to wavefield separation and is presented to enable a person skilled in the art to make and use the disclosed subject matter in the context of one or more particular implementations. Various modifications, alterations, and permutations of the disclosed implementations can be made and will be readily apparent to those skilled in the art, and the general principles defined may be applied to other implementations and applications without departing from the scope of the disclosure. Thus, the present disclosure is not intended to be limited to the described or illustrated implementations, but is to be accorded the widest scope consistent with the principles and features disclosed.

In the elastic wave propagation modeling, complex and simultaneous propagation of elastic wave modes (for example, P-wavefield and S-wavefield) interfere with each other, and can cause artifacts during multi-component seismic imaging and velocity model building. As a result, P-wavefield and S-wavefield separation has been used to separate elastic multi-component wavefields in the time and space domains.

Wavefield separation, based on decoupled wave equations (that is, the decoupled propagation method), separates P- and S-wave equations during numerical modeling. The decoupled propagation method shows competitive performance in computational cost, memory usage, and numerical stability compared to other wavefield separation methods (for example, the selective attenuation method). In addition, since the decoupling of two wave modes (that is, P-wavefield and S-wavefield) is performed implicitly during numerical modeling, the decoupled propagation method is easier and more efficient to implement than other methods using elastic wave propagation modeling. Although decoupled wave equations separate P-wavefield and S-wavefield, false artifacts are observed in separated wavefields generated, for example, by S-wave conversion and reflection. As a result, the decoupled propagation method is not widely used in, for example, velocity model building and depth imaging.

The described approach provides a wavefield separation and filtering method (also referred to as a filtered wavefield separation method). The described wavefield separation and filtering method combines an elastic wavefield separation method, based on decoupled wave equations, with a local orthogonalization weight (LOW) filtering method. For example, LOW filtering is applied following the wavefield separation procedure to enhance signal-to-noise ratio compensating for signal-leakage into the respective separated wavefield components. The decoupled wave equations are used for the wavefield separation procedure to separate P-wavefield and S-wavefield during elastic numerical modeling with efficiency and accuracy. In addition, the LOW filtering is applied on the separated wavefields to remove false artifacts generated during the elastic numerical modeling. By removing the false artifacts, the described wavefield separation and filtering method can be used, for example, in elastic wavefield modelling, elastic full waveform inversion (EFWI), and elastic reverse time migration (ERTM) to obtain cleaner images.

### Wavefield Separation Using Decoupled Wave Equations

Generally, for an elastic isotropic media, the first-order 2D elastic wave equations, in stress and particle-velocity formulation, are expressed as:

Dₜvₓ=b (Dₓτₓₓ+D_{z}τ_{xz}) (1)

Dₜv_{z}=b (Dₓτ_{xz}+D_{z}τ_{zz}) (2)

for particle-velocity component, and

Dₜτₓₓ=(λ+2μ) Dₓvₓ+λD_{z}v_{z} (3)

Dₜτ_{zz}=(λ+2μ) D_{z}v_{z}+λDₓvₓ (4)

Dₜτ_{xz}=μ(Dₓvₓ+D_{z}v_{z}) (5)

for stress component, where

Dᵢ=∂/∂i (i∈{x,z,t}) (6)

(x, z) denotes the 2-dimensional space coordinate, t denotes time, b is the buoyancy (that is, inverse of the density ρ), and λ and μ indicate Lamé coefficients, respectively. v and τ are the particle-velocity component and stress component, respectively. Although this disclosure refers to the first-order 2D elastic wave equations in stress and particle-velocity formulation for purposes of example, the subject matter of this document can be applied to other types of wave equations.

The decoupled propagation method can be used to rewrite the elastic wave equations (that is, Equations (1) to (6)) into separated P- and S-wave components. For example, additional equations, relevant to compressional wave components, can be used to decouple the elastic wave equations and to provide P-wave stress and particle-velocity for both horizontal and vertical components. Accordingly, the following P-wave stress and particle-velocity for both horizontal and vertical components can be obtained by decomposing the elastic wave equations (that is, Equations (1) to (6)):

Dₜv_{xP}=bDₓτ_{P} (7)

Dₜv_{zP}=bD_{z}τ_{P} (8)

Dₜτ_{P}=(λ+2μ) (Dₓvₓ+D_{z}v_{z}) (9)

where the subscript P indicates P-wave mode. v_{xP} and v_{zP} are the P-wave particle-velocity horizontal and vertical components, respectively. τ_{P} is the P-wave stress component. Accordingly, stress and particle-velocity for S-wavefield can be calculated by subtracting the P-wavefield obtained in Equations (7) to (9) from the original (or normal) wavefields obtained in Equations (1) to (6):

v_{xS}=vₓ−v_{xP} (10)

v_{zS}=v_{z}−v_{zP} (11)

where the subscript S indicates S-wave mode. v_{xS} and v_{zS} are the S-wave particle-velocity horizontal and vertical components, respectively.

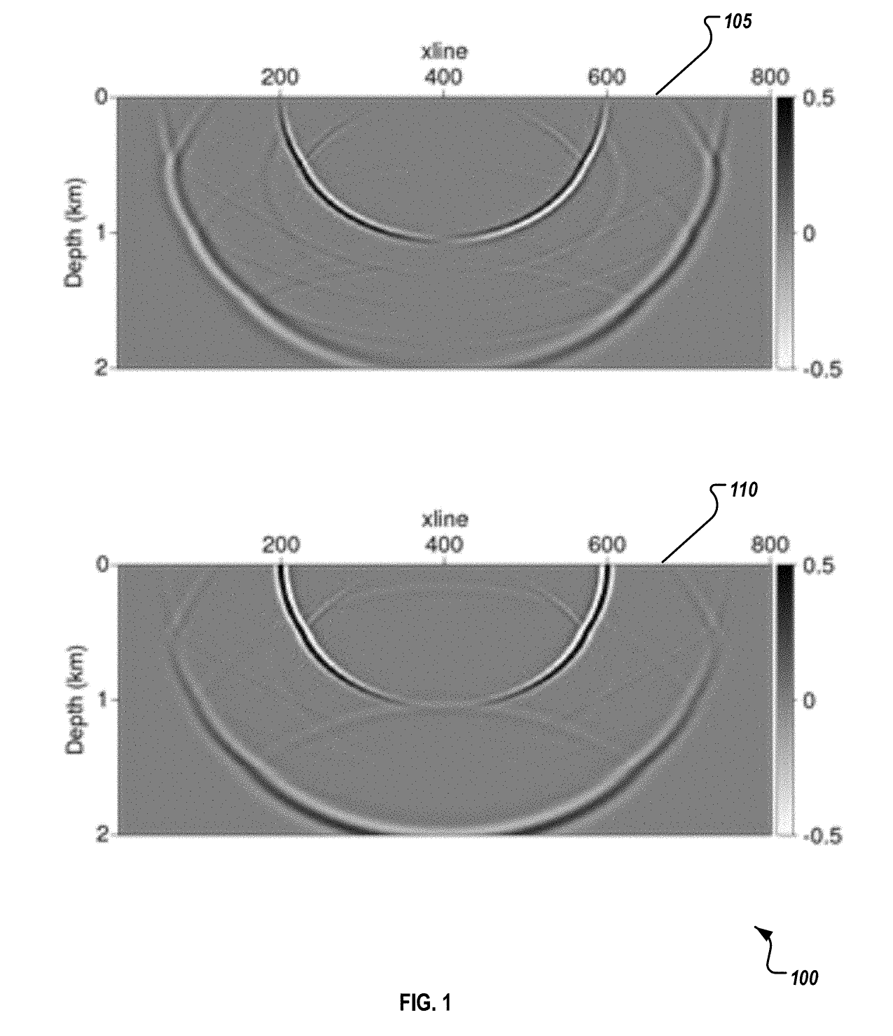

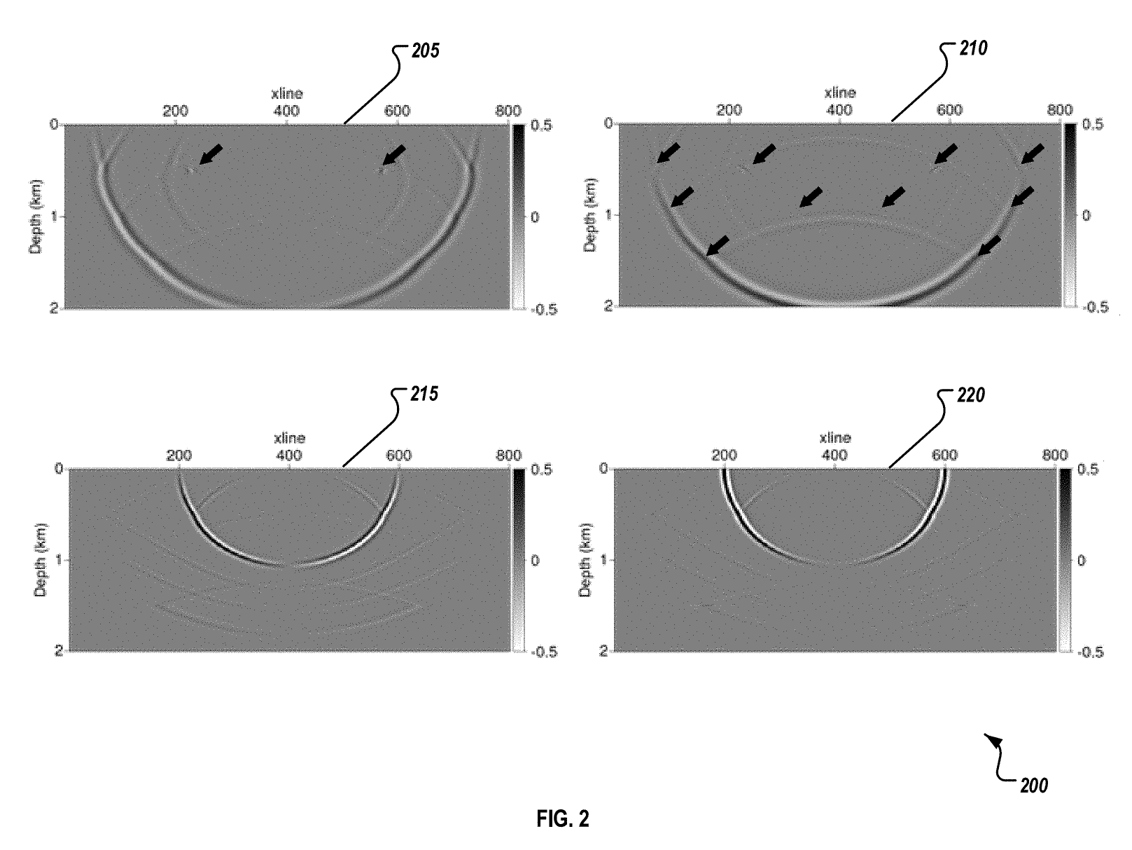

FIG. 1 illustrates example snapshots 100 of horizontal and vertical wavefields, according to some implementations. For example, a four-layer velocity model with three interfaces is simulated for both P- and S-wave velocities. The density model is fixed as a constant. FIG. 1 illustrates a snapshot of the horizontal wavefield 105 and a snapshot of the vertical wavefield 110, both obtained by using, for example, the elastic wave equations (that is, Equations (1) to (6)). In FIG. 1, as well as FIGS. 2, 4, and 6 described later, xline and Depth denote the x axis and z axis, respectively. The snapshot images are generated, for example, using XIMAGE, a tool of SEISMICUNIX.

FIG. 2 illustrates example snapshots 200 of separated P-wavefield and S-wavefield, according to some implementations. In FIG. 2, the horizontal wavefield 105 in FIG. 1 is decomposed using, for example, the decoupled elastic wave equations (that is, Equations (7) to (11)) into the horizontal P-wavefield 205 and the horizontal S-wavefield 215. The vertical wavefield 110 in FIG. 1 is decomposed using, for example, the decoupled elastic wave equations (that is, Equations (7) to (11)) into the vertical P-wavefield 210 and the vertical S-wavefield 220. False artifacts at locations identified by arrows are shown in the horizontal P-wavefield 205 and the vertical P-wavefield 210. The locations identified by the arrows are places where P- to S-conversion and S-wave reflection are taking place. In some implementations, the false artifacts can be suppressed when a smoother velocity model with smoother interfaces, rather than the four-layer velocity model with three interfaces described in FIG. 1, is used. However, when performing reverse time migration (RTM) and full waveform inversion (FWI) with more complex velocity models, false artifacts may not be suppressed.

### Local Orthogonalization Weight (LOW) Computation

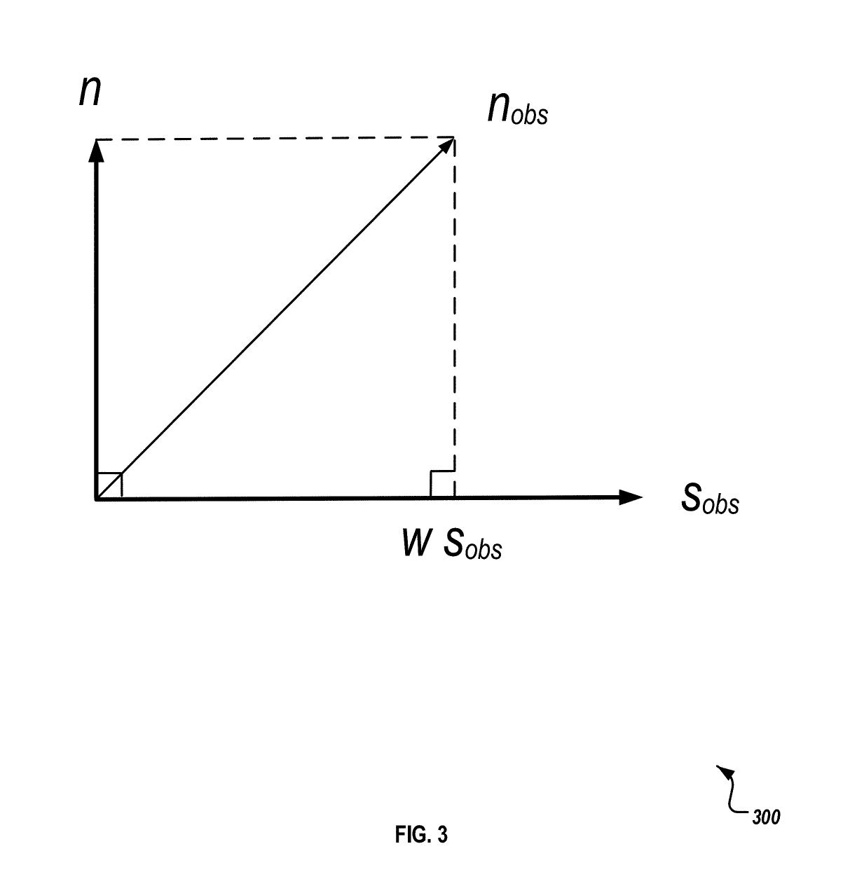

FIG. 3 is a diagram illustrating an example orthogonality 300 between signal and noise, according to some implementations. In FIG. 3, s_{obs} and n_{obs} denote the initially observed signal and noise, after the denoising or filtering process, respectively. s and n denote the final estimated signal and noise, respectively. w is a weighting operator which weights the observed signal. The observed signal corresponds to the signal energy left in the noise component. To obtain the weighting operator w, an optimization problem can be set up to minimize the residual between the leakage signal energy in the observed noise and the weighted signal w*s_{obs}:

$$w = arg {min}_{w} {‖ {n}_{obs} - diag ( {s}_{obs} ) w ‖}_{2}^{2} + R ( w ) \qquad ( 12 )$$

where diag(a) denotes a diagonal matrix which consists of the elements of the original vector a, and R is a smoothing regularization operator. Note that diag(s_{obs}) w=diag(w) s_{obs}. The solution of the least-squares problem (that is, Equation (12)) produces a local weighting vector that minimizes the signal leakage in the noise component. As a result, the final estimation of the signal and noise are expressed as:

s=s_{obs}+diag (w) s_{obs}=s_{obs}+diag (s_{obs}) w (13)

n=n_{obs}−diag (w) s_{obs}=n_{obs}−diag (s_{obs}) w (14)

In the LOW computation, one assumption is that the signal and noise are orthogonal and cannot be correlated with each other. In addition, there are two inputs for the LOW computation. For example, if original and separated wavefields are the first and second input, respectively, the LOW computation (Equations (12) to (14)) produces filtered wavefields by enhancing seismic events that are common to both inputs and ignoring seismic events that are not locally correlated. The filtered wavefields can be used in a number of applications using elastic wave propagation equations (for example, elastic numerical modeling, computation of the gradient during elastic full waveform inversion (EFWI), and elastic reverse time migration (ERTM)) to provide more accurate results (for example, cleaner depth images) than using the original or separated wavefields.

### Filtering the Separated Wavefields by LOW

The wavefield separation and filtering method described next denoises, in the image domain (or space domain), separated wavefields by computing local orthogonality weight between the separated P-wavefield and S-wavefield during wave propagation modeling. According to the decoupled wave equations (that is, Equations (7) to (11)), the corresponding horizontal and vertical components of the P-wavefield and S-wavefield with false artifacts (also referred to as noise) are expressed as:

v_{xP}=v_{xP}^{t}+v_{xP}ⁿ (15)

v_{zP}=v_{zP}^{t}+v_{zP}ⁿ (16)

### for P-wave, and

v_{xS}=v_{xS}^{t}+v_{xS}ⁿ (17)

v_{zS}=v_{zS}^{t}+v_{zS}ⁿ (18)

for S-wave, where the superscripts t and n indicate noise-free component (that is, true value) and noise component, respectively.

To apply LOW to the separated wavefields, it is assumed that the horizontal P-wave particle-velocity v_{xP} is the observed noise n_{obs} and the horizontal particle-velocity vₓ is the observed signal s_{obs} in Equation (12). As a result, a new least-squares problem is obtained as:

$${w}_{P} = arg {min}_{{w}_{P}} {‖ {v}_{xP} - diag ( {v}_{x} ) {w}_{P} ‖}_{2}^{2} + R ( {w}_{P} ) \qquad ( 19 )$$

Equation (19) solves for a weighting operator w_{P}, which retrieves signal vₓ left at v_{xP}. According to Equations (13) to (16), the final estimation of the noise on the horizontal P-wavefield is:

v_{xP}ⁿ=v_{xP}−diag (w_{P}) vₓ (20)

and the final estimation of the noise-free signal on the horizontal P-wavefield is:

v_{xP}^{t}=v_{xP}−v_{xP}ⁿ (21)

From Equations (20) and (21), the final estimation of the noise-free signal on the horizontal P- wavefield, which presents the signal after both wavefield separation and orthogonalization filtering, is:

v_{xP}^{t}=diag (w_{P}) vₓ (22)

A similar process (for example, Equations (19) to (22)) can be applied for the vertical P-wavefield to obtain the final estimation of the noise-free signal on the vertical P-wavefield, v_{zP}^{t}.

For the S-wave component, it is assumed that the horizontal S-wave particle-velocity v_{xS} is the observed noise n_{obs} and the horizontal particle-velocity vₓ is the observed signal s_{obs} in Equation (12). As a result, another least-squares problem is obtained as:

$${w}_{S} = arg {min}_{{w}_{S}} {‖ {v}_{xS} - diag ( {v}_{x} ) {w}_{S} ‖}_{2}^{2} + R ( {w}_{S} ) \qquad ( 23 )$$

Equation (23) solves for a weighting operator w_{S}, which retrieves signal vₓ left at v_{xS}. According to Equations (13) to (16), the final estimation of the noise on the horizontal S-wavefield is:

v_{xS}ⁿ=v_{xS}−diag (w_{S}) vₓ (24)

and the final estimation of the noise-free signal on the horizontal S-wavefield is:

v_{xS}^{t}=v_{xS}−v_{xS}ⁿ (25)

From Equations (24) and (25), the final estimation of the noise-free signal on the horizontal S-wavefield, which presents the signal after both wavefield separation and orthogonalization filtering, is:

v_{xS}^{t}=diag (w_{S}) vₓ (26)

A similar process (for example, Equations (23) to (26)) can be applied for the vertical S-wavefield to obtain the final estimation of the noise-free signal on the vertical S-wavefield, v_{zS}^{t}.

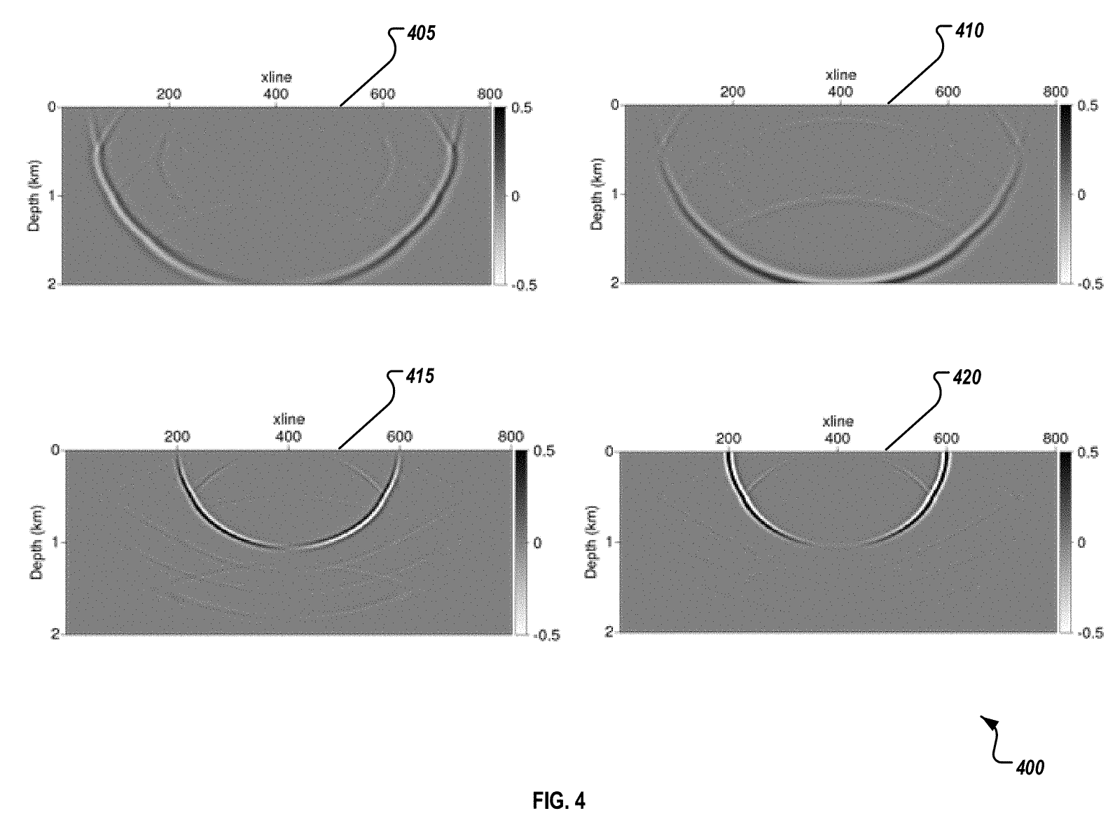

FIG. 4 illustrates example snapshots 400 of filtered P-wavefield and S-wavefield, according to some implementations. In FIG. 4, the separated wavefields 205, 210, 215, and 220 in FIG. 2 are filtered using, for example, LOW filtering (that is, Equations (15) to (26)) to produce the filtered horizontal P-wavefield 405, the filtered vertical P-wavefield 410, the filtered horizontal S-wavefield 415, and the filtered vertical S-wavefield 420, respectively. The filtered horizontal P-wavefield 405 and the filtered vertical P-wavefield 410 show the removal of the false artifacts, observed in the horizontal P-wavefield 205 and the vertical P-wavefield 210 in FIG. 2. FIG. 4 illustrates that the LOW filtering performs very well in noise suppression on separated wavefields.

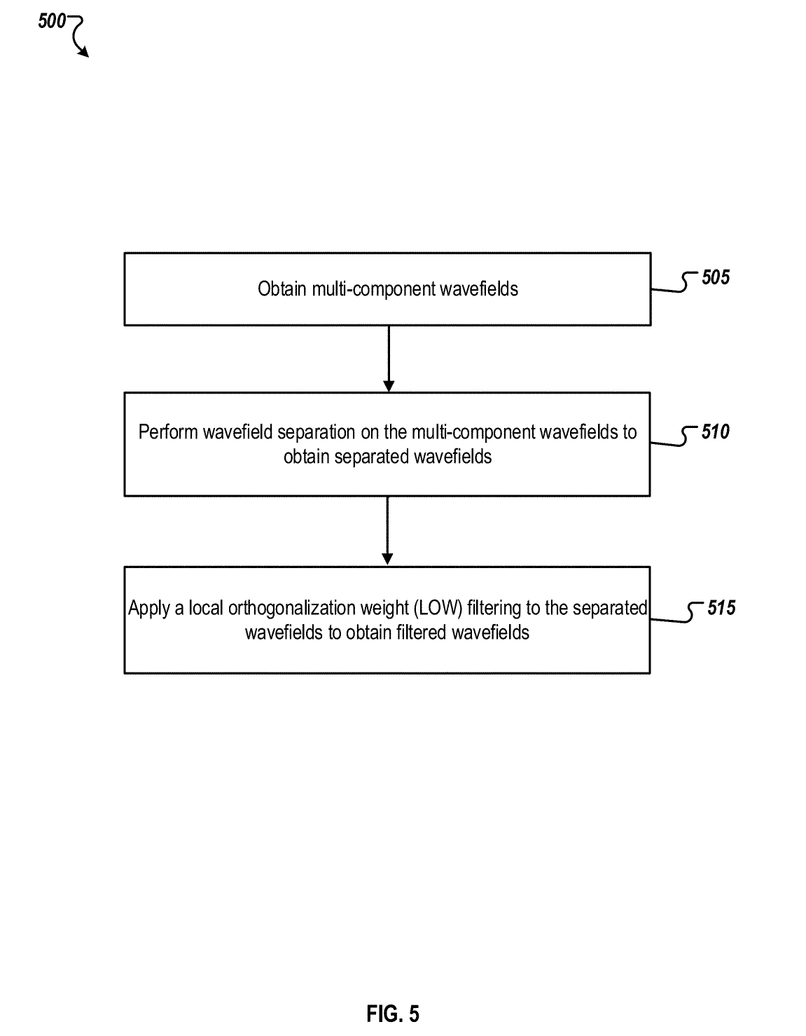

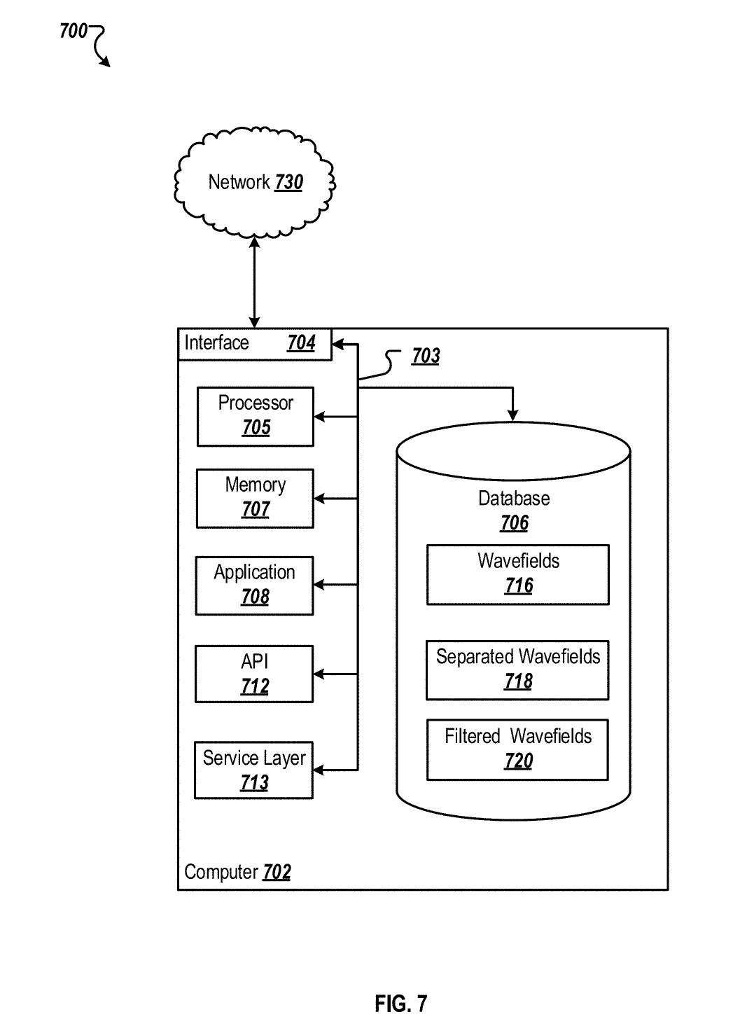

FIG. 5 is a flowchart illustrating an example method 500 for applying orthogonalization filtering to wavefield separation, according to some implementations. For clarity of presentation, the description that follows generally describes method 500 in the context of the other figures in this description. For example, method 500 can be performed by a computer system described in FIG. 7. However, it will be understood that method 500 may be performed, for example, by any suitable system, environment, software, and hardware, or a combination of systems, environments, software, and hardware, as appropriate. In some implementations, various steps of method 500 can be run in parallel, in combination, in loops, or in any order.

The method 500 starts at block 505 where multi-component wavefields are obtained. In some implementations, the multi-component wavefields are formed using a time-domain elastic wave propagation model based on first-order 2D elastic wave equations (for example, Equations (1) to (6)). The multi-component wavefields include a horizontal component and a vertical component. In some implementations, the first-order 2D elastic wave equations are written in a stress and particle-velocity formulation. In some implementations, a staggered-grid finite-difference method (such as, staggered stencil or staggered grid) can be used to implement the propagation model.

At block 510, wavefield separation is performed on the multi-component wavefields to obtain separated wavefields. In some implementations, the wavefield separation is performed using a P-wavefield and S-wavefield separation method (for example, a decoupled propagation method). After the wavefield separation, the separated wavefields include at least one of a P-wavefield for the horizontal component, a P-wavefield for the vertical component, an S-wavefield for the horizontal component, or an S-wavefield for the vertical component. In some implementations, performing the wavefield separation includes decoupling the first-order 2D elastic wave equations into separate P-wave and S-wave components (for example, Equations (7) to (11)) and separating the multi-component wavefields based on the decoupled first-order 2D elastic wave equations. In some implementations, decoupling the first-order 2D elastic wave equations is performed using a set of equations (for example, Equations (7) to (9)) associated with compressional wave components providing P-wave stress and particle-velocity for both the horizontal component and the vertical component.

At block 515, a local orthogonalization weight (LOW) filtering is applied to the separated wavefields to obtain filtered wavefields. In some implementations, for each wavefield in the separated wavefields, a local orthogonalization weight is calculated (for example, Equations (19) and (23)). And for each wavefield in the separated wavefields, a filtered wavefield (for example, Equation (22), Equation (26)) is obtained by applying the calculated local orthogonalization weight to a corresponding component of the multi-component wavefields (for example, Equations (20) to (21), Equations (24) to (25)).

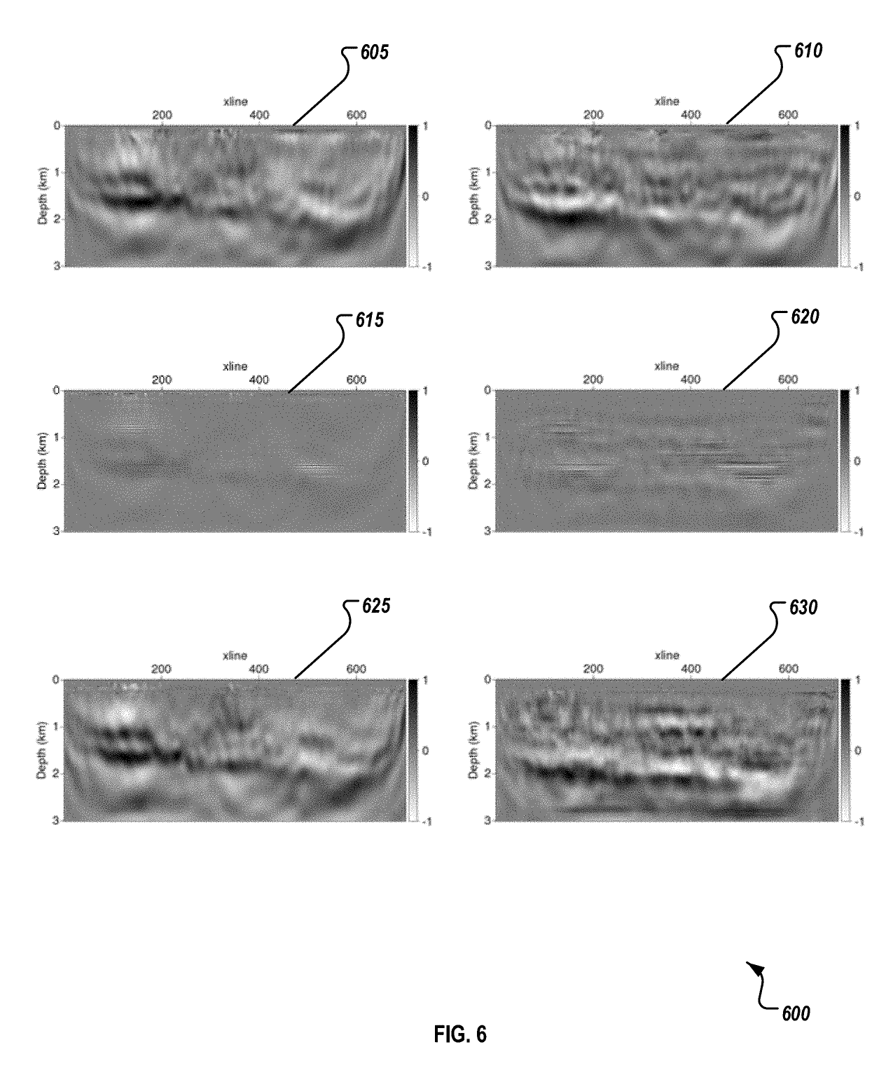

The example method 500 shown in FIG. 5 can be modified or reconfigured to include additional, fewer, or different steps (not shown in FIG. 5), which can be performed in the order shown or in a different order. For example, after block 515, an image (for example, a depth image of underground oil reservoirs) can be calculated based on the filtered wavefields. In some implementations, the filtered and separated wavefields are used to calculate the gradient direction for the elastic full waveform inversion (EFWI), the imaging condition of the elastic reverse time migration (ERTM), or a combination of both. For example, images (such as, 625 and 630 in FIG. 6 described later) can be obtained from EFWI using LOW filtering, and each image can be used to update elastic parameter (such as, P-wave velocity, S-wave velocity). In addition, the updated elastic parameter can be used in the depth imaging by reverse time migration (RTM). In some implementations, one or more of the steps shown in FIG. 5 can be repeated or iterated, for example, until a terminating condition is reached. In some implementations, one or more of the individual steps shown in FIG. 5 can be executed as multiple separate steps, or one or more subsets of the steps shown in FIG. 5 can be combined and executed as a single step. In some implementations, one or more of the individual steps shown in FIG. 5 may also be omitted from the example method 500.

FIG. 6 illustrates example snapshots 600 of normalized gradient directions, according to some implementations. To investigate an applicability and effectiveness of LOW filtering on wavefield separation, 2D elastic full waveform inversion (EFWI) is performed, for example, to a land dataset. Since the observed data of the land dataset only has a vertical component, the P-wave mode is dominant for forward and backward modeling. As a result, gradient directions are calculated by the PP wave mode to retrieve P-wave velocity, and the PS wave mode to retrieve S-wave velocity, respectively. FIG. 6 illustrates the gradient directions at the 6^{th} iteration for P- and S-wave velocities. In FIG. 6, the normalized gradient directions for P-wave velocity 605 and the normalized gradient directions for S-wave velocity 610 are obtained, for example, from conventional FWI, and are wrapped images by the intrinsic characteristic of the conventional EFWI. As shown in FIG. 6, the images are similar with opposite polarity. The normalized gradient directions for P-wave velocity 615 and the normalized gradient directions for S-wave velocity 620 are obtained, for example, from wavefield separation using PP and PS correlation. The normalized gradient directions for P-wave velocity 615 and the normalized gradient directions for S-wave velocity 620 are contaminated with horizontal noise stripes due to crosstalk and interference generated from the P- and S-wavefields. The normalized gradient directions for P-wave velocity 625 and the normalized gradient directions for S-wave velocity 630 are obtained, for example, from wavefield separation using PP and PS correlation (that is, decoupling the elastic waves) combined with LOW filtering. The normalized gradient directions for P-wave velocity 625 and the normalized gradient directions for S-wave velocity 630 show that wavefield separation followed by LOW filtering can provide robust and less noisy gradient directions for both PP and PS wavefields.

FIG. 7 is a block diagram of an example computer system 700 used to provide computational functionalities associated with described algorithms, methods, functions, processes, flows, and procedures as described in the instant disclosure, according to an implementation. The illustrated computer 702 is intended to encompass any computing device such as a server, desktop computer, laptop/notebook computer, wireless data port, smart phone, personal data assistant (PDA), tablet computing device, one or more processors within these devices, or any other suitable processing device, including physical or virtual instances (or both) of the computing device. Additionally, the computer 702 may comprise a computer that includes an input device, such as a keypad, keyboard, touch screen, or other device that can accept user information, and an output device that conveys information associated with the operation of the computer 702, including digital data, visual, or audio information (or a combination of information), or a graphical user interface (GUI).

The computer 702 can serve in a role as a client, network component, a server, a database or other persistency, or any other component (or a combination of roles) of a computer system for performing the subject matter described in the instant disclosure. The illustrated computer 702 is communicably coupled with a network 730. In some implementations, one or more components of the computer 702 may be configured to operate within environments, including cloud-computing-based, local, global, or other environment (or a combination of environments).

The computer 702 is an electronic computing device operable to receive, transmit, process, store, or manage data and information associated with the described subject matter. According to some implementations, the computer 702 may also include or be communicably coupled with an application server, e-mail server, web server, caching server, streaming data server, or other server (or a combination of servers).

The computer 702 can receive requests over network 730 from a client application (for example, executing on another computer) and respond to the received requests by processing the received requests using the appropriate software application(s). In addition, requests may also be sent to the computer 702 from internal users (for example, from a command console or by another internal access method), external or third-parties, other automated applications, as well as any other appropriate entities, individuals, systems, or computers.

Each of the components of the computer 702 can communicate using a system bus 703. In some implementations, any or all of the components of the computer 702, both hardware or software (or a combination of hardware and software), may interface with each other or the interface 704 (or a combination of both) over the system bus 703 using an application programming interface (API) 712 or a service layer 713 (or a combination of the API 712 and service layer 713). The API 712 may include specifications for routines, data structures, and object classes. The API 712 may be either computer-language independent or dependent and may refer to a complete interface, a single function, or even a set of APIs. The service layer 713 provides software services to the computer 702 or other components (whether or not illustrated) that are communicably coupled to the computer 702. The functionality of the computer 702 may be accessible for all service consumers using this service layer. Software services, such as those provided by the service layer 713, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 702, alternative implementations may illustrate the API 712 or the service layer 713 as stand-alone components in relation to other components of the computer 702 or other components (whether or not illustrated) that are communicably coupled to the computer 702. Moreover, any or all parts of the API 712 or the service layer 713 may be implemented as child or sub-modules of another software module, enterprise application, or hardware module, without departing from the scope of this disclosure.

The computer 702 includes an interface 704. Although illustrated as a single interface 704 in FIG. 7, two or more interfaces 704 may be used according to particular needs, desires, or particular implementations of the computer 702. The interface 704 is used by the computer 702 for communicating with other systems that are connected to the network 730 (whether illustrated or not) in a distributed environment. Generally, the interface 704 comprises logic encoded in software or hardware (or a combination of software and hardware) and is operable to communicate with the network 730. More specifically, the interface 704 may comprise software supporting one or more communication protocols associated with communications such that the network 730 or interface's hardware is operable to communicate physical signals within and outside of the illustrated computer 702.

The computer 702 includes a processor 705. Although illustrated as a single processor 705 in FIG. 7, two or more processors may be used according to particular needs, desires, or particular implementations of the computer 702. Generally, the processor 705 executes instructions and manipulates data to perform the operations of the computer 702 and any algorithms, methods, functions, processes, flows, and procedures as described in the instant disclosure.

The computer 702 also includes a database 706 that can hold data for the computer 702 or other components (or a combination of both) that can be connected to the network 730 (whether illustrated or not). For example, database 706 can be an in-memory, conventional, or other type of database storing data consistent with this disclosure. In some implementations, database 706 can be a combination of two or more different database types (for example, a hybrid in-memory and conventional database) according to particular needs, desires, or particular implementations of the computer 702 and the described functionality. Although illustrated as a single database 706 in FIG. 7, two or more databases (of the same or combination of types) can be used according to particular needs, desires, or particular implementations of the computer 702 and the described functionality. While database 706 is illustrated as an integral component of the computer 702, in alternative implementations, database 706 can be external to the computer 702. As illustrated, the database 706 holds wavefields 716, separated wavefields 718, and filtered wavefields 720.

The computer 702 also includes a memory 707 that can hold data for the computer 702 or other components (or a combination of both) that can be connected to the network 730 (whether illustrated or not). For example, memory 707 can be random access memory (RAM), read-only memory (ROM), optical, magnetic, and the like, storing data consistent with this disclosure. In some implementations, memory 707 can be a combination of two or more different types of memory (for example, a combination of RAM and magnetic storage) according to particular needs, desires, or particular implementations of the computer 702 and the described functionality. Although illustrated as a single memory 707 in FIG. 7, two or more memories 707 (of the same or a combination of types) can be used according to particular needs, desires, or particular implementations of the computer 702 and the described functionality. While memory 707 is illustrated as an integral component of the computer 702, in alternative implementations, memory 707 can be external to the computer 702.

The application 708 is an algorithmic software engine providing functionality according to particular needs, desires, or particular implementations of the computer 702, particularly with respect to functionality described in this disclosure. For example, application 708 can serve as one or more components, modules, or applications. Further, although illustrated as a single application 708, the application 708 may be implemented as multiple applications 708 on the computer 702. In addition, although illustrated as integral to the computer 702, in alternative implementations, the application 708 can be external to the computer 702.

There may be any number of computers 702 associated with, or external to, a computer system containing computer 702, each computer 702 communicating over network 730. Further, the term “client”, “user”, and other appropriate terminology may be used interchangeably, as appropriate, without departing from the scope of this disclosure. Moreover, this disclosure contemplates that many users may use one computer 702, or that one user may use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include, special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or be described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM), or both. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20, or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of this disclosure or on the scope of what may be claimed, but rather as descriptions of features that may be specific to particular implementations of this disclosure. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously-described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously-described implementations should not be understood as requiring such separation or integration in all implementations, and it should be understood that the described program components and systems can generally be integrated together in a single software product or packaged into multiple software products.

Accordingly, the previously-described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A method comprising:
obtaining multi-component wavefields;
performing wavefield separation on the multi-component wavefields to obtain separated wavefields; and
applying a local orthogonalization weight (LOW) filtering to the separated wavefields to obtain filtered wavefields.

2. The method of claim 1, further comprising calculating a depth image based on the filtered wavefields.

3. The method of claim 1, wherein the multi-component wavefields are formed using a time-domain elastic wave propagation model based on first-order 2D elastic wave equations, and the multi-component wavefields include a horizontal component and a vertical component.

4. The method of claim 3, wherein the separated wavefields include at least one of a P-wavefield for the horizontal component, a P-wavefield for the vertical component, an S-wavefield for the horizontal component, or an S-wavefield for the vertical component.

5. The method of claim 3, wherein performing wavefield separation comprises:
decoupling the first-order 2D elastic wave equations into separate P-wave and S-wave components; and
separating the multi-component wavefields based on the decoupled first-order 2D elastic wave equations.

6. The method of claim 5, wherein first-order 2D elastic wave equations are written in a stress and particle-velocity formulation, and decoupling the first-order 2D elastic wave equations is performed using a set of equations associated with compressional wave components providing P-wave stress and particle-velocity for both the horizontal component and the vertical component.

7. The method of claim 3, wherein applying the LOW filtering comprises:
for each wavefield in the separated wavefields:
calculating a local orthogonalization weight; and
obtaining a filtered wavefield by applying the calculated local orthogonalization weight to a corresponding component of the multi-component wavefields.

8. The method of claim 1, wherein the wavefield separation is performed using a P-wavefield and S-wavefield separation method.

9. A device comprising:
a memory; and
a processing unit that is arranged to perform operations including:
obtaining multi-component wavefields;
performing wavefield separation on the multi-component wavefields to obtain separated wavefields; and
applying a local orthogonalization weight (LOW) filtering to the separated wavefields to obtain filtered wavefields.

10. The device of claim 9, the operations further comprising calculating a depth image based on the filtered wavefields.

11. The device of claim 9, wherein the multi-component wavefields are formed using a time-domain elastic wave propagation model based on first-order 2D elastic wave equations, and the multi-component wavefields include a horizontal component and a vertical component.

12. The device of claim 11, wherein the separated wavefields include at least one of a P-wavefield for the horizontal component, a P-wavefield for the vertical component, an S-wavefield for the horizontal component, or an S-wavefield for the vertical component.

13. The device of claim 11, wherein performing wavefield separation comprises:
decoupling the first-order 2D elastic wave equations into separate P-wave and S-wave components; and
separating the multi-component wavefields based on the decoupled first-order 2D elastic wave equations.

14. The device of claim 13, wherein first-order 2D elastic wave equations are written in a stress and particle-velocity formulation, and decoupling the first-order 2D elastic wave equations is performed using a set of equations associated with compressional wave components providing P-wave stress and particle-velocity for both the horizontal component and the vertical component.

15. The device of claim 11, wherein applying the LOW filtering comprises:
for each wavefield in the separated wavefields:
calculating a local orthogonalization weight; and
obtaining a filtered wavefield by applying the calculated local orthogonalization weight to a corresponding component of the multi-component wavefields.

16. The device of claim 9, wherein the wavefield separation is performed using a P-wavefield and S-wavefield separation method.

17. A non-transitory computer-readable medium storing instructions executable by a computer system to perform operations comprising:
obtaining multi-component wavefields;
performing wavefield separation on the multi-component wavefields to obtain separated wavefields; and
applying a local orthogonalization weight (LOW) filtering to the separated wavefields to obtain filtered wavefields.

18. The medium of claim 17, the operations further comprising calculating a depth image based on the filtered wavefields.

19. The medium of claim 17, wherein the multi-component wavefields are formed using a time-domain elastic wave propagation model based on first-order 2D elastic wave equations, and the multi-component wavefields include a horizontal component and a vertical component.

20. The medium of claim 19, wherein the separated wavefields include at least one of a P-wavefield for the horizontal component, a P-wavefield for the vertical component, an S-wavefield for the horizontal component, or an S-wavefield for the vertical component.
